(19) United States
(12) Patent Application Publication
(10) Pub. No.: US 2016/0300260 A1
(43) Pub. Date: Oct. 13, 2016

(54) METHODS FOR OPTIMIZING ADVERTISING TRAFFIC WITH CONTINUOUSLY OPTIMIZED AFFILIATE LINKS

(71) Applicant: Clickbooth.com, LLC, Sarasota, FL (US)

(72) Inventors: Erin Cigich, Sarasota, FL (US); John Daniel Lemp, Sarasota, FL (US); Sarah Chase, Sarasota, FL (US); Cara Redding, Sarasota, FL (US); Dzenis Softic, Sarasota, FL (US); Zeljko Mandic, Sarasota, FL (US)

(21) Appl. No.: 15/096,133

(22) Filed: Apr. 11, 2016

Related U.S. Application Data
(60) Provisional application No. 62/145,372, filed on Apr. 9, 2015.

(51) Int. Cl. G06Q 30/02

(52) U.S. Cl. CPC G06Q 30/0244; G06Q 30/0277

(57) ABSTRACT

Aspects of the present disclosure are presented for optimizing advertising traffic with continuously optimized affiliate links. In some embodiments, a method is presented. The method may include receiving an offer for an advertiser link to be placed onto an affiliate website, the advertiser link directing a customer to a website of the advertiser, and placing the advertiser link onto the affiliate website. The method may also include monitoring customer traffic to the advertiser link on the affiliate website; determining that the use of the advertiser link on the affiliate website has expired, based on the monitored traffic; accessing an optimally generated alternate link; removing the advertiser link from the affiliate website; and including the alternate link in the affiliate website in place of the advertiser link.

### CROSS REFERENCE TO RELATED APPLICATION

This application claims the benefit of U.S. Provisional Application 62/145,372, filed Apr. 9, 2015, and titled, “METHODS FOR OPTIMIZING ADVERTISING TRAFFIC WITH CONTINUOUSLY OPTIMIZED AFFILIATE LINKS,” the disclosure of which is incorporated herein by reference in its entirety and for all purposes.

### TECHNICAL FIELD

The subject matter disclosed herein generally relates to processing data. In some embodiments, the present disclosures relate to methods and apparatuses for optimizing advertising traffic with continuously optimized affiliate links.

### BRIEF DESCRIPTION OF THE DRAWINGS

Some embodiments are illustrated by way of example and not limitation in the figures of the accompanying drawings.

FIG. 1A is a network diagram illustrating an example network environment suitable for performing aspects of the present disclosure, according to some embodiments.

FIG. 1B is a relational diagram illustrating relational interactions between customers and the system of the third party marketing company, according to some embodiments.

FIG. 2 shows an example display of various information for running an ad campaign, according to some embodiments.

FIG. 3 shows a second example display of various traffic sources for running an ad campaign, according to some embodiments.

FIG. 4 shows a third example display of various campaigns running simultaneously by the advertiser, according to some embodiments.

FIG. 5 shows a fourth example display of a scheduling interface for scheduling when to display links associated with an ad campaign, according to some embodiments.

FIG. 6 shows a fifth example display showing revenue information that may be generated from one or more ad campaigns, according to some embodiments.

FIG. 7A provides an example methodology for facilitating advertising links on an affiliate website, using an advertiser link and an alternate link when the budget to display the advertiser link has reached its limit, according to some embodiments.

FIG. 7B provides additional details for performing block 704, such as performing auto testing, according to some embodiments.

FIG. 7C provides another example methodology providing additional details for performing block 704, such as performing dynamic pricing, according to some embodiments.

FIG. 8 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for optimizing advertising traffic with continuously optimized affiliate links. Online marketing has quickly become a vital component for businesses to advertise their products and brands. Third party online marketing companies have developed to help facilitate the interactions between advertisers, e.g., a car company, a shoe company, a beverage company, or a marketing company contracted to advertise on behalf of other companies, and publishers (also referred to as affiliates), e.g., a news website, a sports website, a blog, a website of an online store, a media buyer who purchases ad space on a website, network, or ad exchange to drive traffic to an offer landing page, or a publishing company contracted to manage websites on behalf of other companies. Advertisements may also be placed in email newsletters or other types of emails controlled by an affiliate, and so an affiliate may also include email marketing companies according to some embodiments. An online ad typically includes, along with the advertisement itself, a link to a website of the advertiser that, when the ad is clicked on by a customer, directs the customer's web browser to the website of the advertiser. The third party online marketing company may help place advertisers' ads into a publisher's website, and may help monitor and improve the performance of those ads to better match the preferences for types of ads web viewers of the publisher (also referred to as customers) may prefer or be more drawn to.

In a traditional affiliate/performance marketing network operated by the third party online marketing company, advertisers who wish to disseminate their ads to consumers are matched with publishers (affiliates) who have access to certain traffic through a variety of traffic sources (e.g., email, display advertising, search, etc.). As used herein, traffic refers to the amount of views or time spent on a publisher's website (affiliate website) based on aggregate customer actions. This matching is typically done on a one to one basis, which typically requires human intervention and input. Advertisers typically create ad campaigns that specify what online ads they wish to run (e.g., content of the ad, and type of online ad, such as pop up ad, banner ad, scrolling ad, etc.), and may also specify when they want the ads run, how frequently, and in some cases on what websites. Advertisers typically pay an affiliate to run their ad, where the prices may be a one-size-fits-all flat rate based on completed actions by customers (e.g., sales, leads, signups, etc.). Advertisers often cap their campaigns at a designated budget (often a daily budget), after which their online ad is no longer available for distribution by the publisher (i.e., affiliate).

At the point where the advertiser's budget to run the ad is used up (e.g., the daily budget is reached), such that the advertiser's ad will no longer be displayed in the affiliate website, the third party marketing company may typically rely upon a team of employees to manage traffic of the affiliate website. As advertisers reach their daily budget limits, these individuals are tasked with identifying alternate offers (e.g. alternative online ads) which may be suitable for the affiliates to utilize. For example, other offers from within the system may be suitable replacements for the offer a particular affiliate is promoting when this cap is reached. The traffic management team then works with the affiliates to change their campaign link from the one which has reached its cap (e.g., the link of the advertiser's online ad) to the new, alternate link.

In addition, alternate links may be utilized for other reasons besides the fact that an advertiser's budget has been used up. For example, it is likely that depending on several factors of metadata associated with a customer, (e.g., geolocation, device type, etc.) and competition between advertisers for displaying links on affiliate online content (e.g.—bids from other advertisers), the affiliate may be running campaigns of the advertiser and of the alternate link simultaneously.

Additionally, every time a new campaign is launched, in conventional methods, the third party marketing company must work with each affiliate in order to test the ads of the advertiser's ad campaign on their traffic. This process typically takes approximately two weeks on average before any statistically relevant data is gained.

Aspects of the present disclosure are presented to automate, optimize and streamline the process for placing advertisements into affiliate websites. In some embodiments, the process for generating the alternate link and replacing the expired campaign link with the alternate link is automated, including determining an optimal selection of the alternate link, through the utilization of an optimization algorithm running on a server of the third party marketing company. In some embodiments, through the utilization of a program on the server of the third party marketing company, advertisers are allowed to set their daily budget (i.e., cap) and affiliates are able to utilize a single link, which never has to be replaced and which links to campaigns that are most effective for their traffic on an ongoing basis. This eliminates the need to replace links, and reduces the financial barrier to entry for advertisers wishing to utilize the network (minimum daily budget, etc.) to virtually none.

In addition, in some embodiments, the testing procedures to evaluate the fit of an ad campaign with an affiliate are automated such that the testing process may be unnoticeable to an affiliate. In addition, the automated testing procedures may complete much earlier than the typical two week period required through conventional human testing, allowing the ad campaign cycles to reach their intended target bases more quickly. For example, the automated testing system according to aspects of the present disclosure may improve testing time form a number of weeks down to a matter of minutes or hours.

In some embodiments, the program of the third party marketing company improves upon the relatively flat pricing that exists in the current affiliate marketplace. In most instances (e.g., 90%), advertisers pay a flat cost-per-acquisition regardless of the lifetime value of the consumer or of the value of a particular affiliate's traffic. This is due to the manpower that would be required in order to constantly manually calculate and then update payouts. The program of the third party marketing company allows each click (and therefore each consumer) to be properly valued or “right priced,” according to some embodiments. In addition, in some embodiments, the placement of the ad may be dynamically priced, and may depend on various factors, such as the popularity of the affiliate website, the type of ad being run, the time at which the ad is run, and so on. In some embodiments, these factors may be reflected in a bidding process to determine the true market value of any ad placement.

In some embodiments, an affiliate user interface (UI) is provided that supports desktop, tablet and mobile devices where affiliates can register their account and log in. Once logged in, an affiliate can create “links” where the web traffic will be sent to and read statistics of the traffic they have, more specifically, number of clicks and generated revenue.

In some embodiments, an advertiser UI is provided that supports desktop, tablet and mobile devices where advertisers can register their accounts and log in. Once logged in, an advertiser can create “campaigns” where the advertiser can define what kind of traffic they want and how much are they willing to pay for. Full statistics in terms of how many clicks, conversions (if available) and cost is generated is available, in some embodiments.

In some embodiments, an admin UI is provided that supports desktop, table and mobile devices where personnel of the third party marketing company can manage the system with respect to, for example, managing affiliates, managing advertisers, and managing campaigns and statistics.

In some embodiments, a program is provided that monitors web ports (including, but not limited to 80 and 443) and is configured to generate advertising links for affiliates where the traffic is sent to, matching the traffic with the best converting available campaign from advertisers and writing statistics to a database.

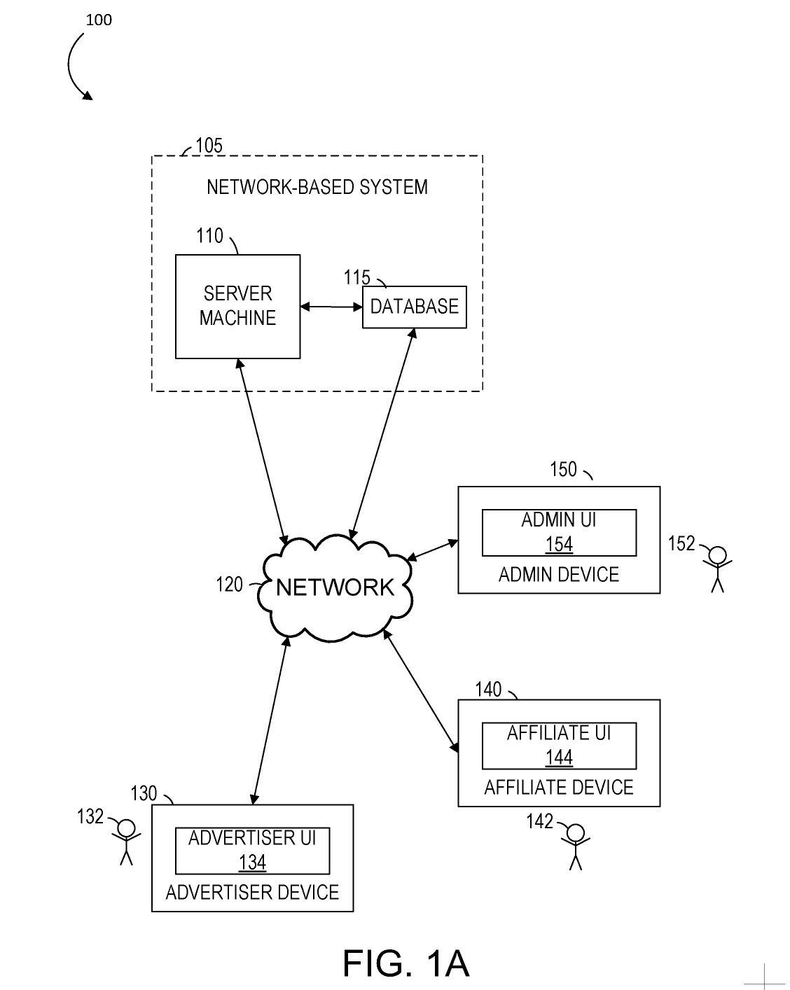

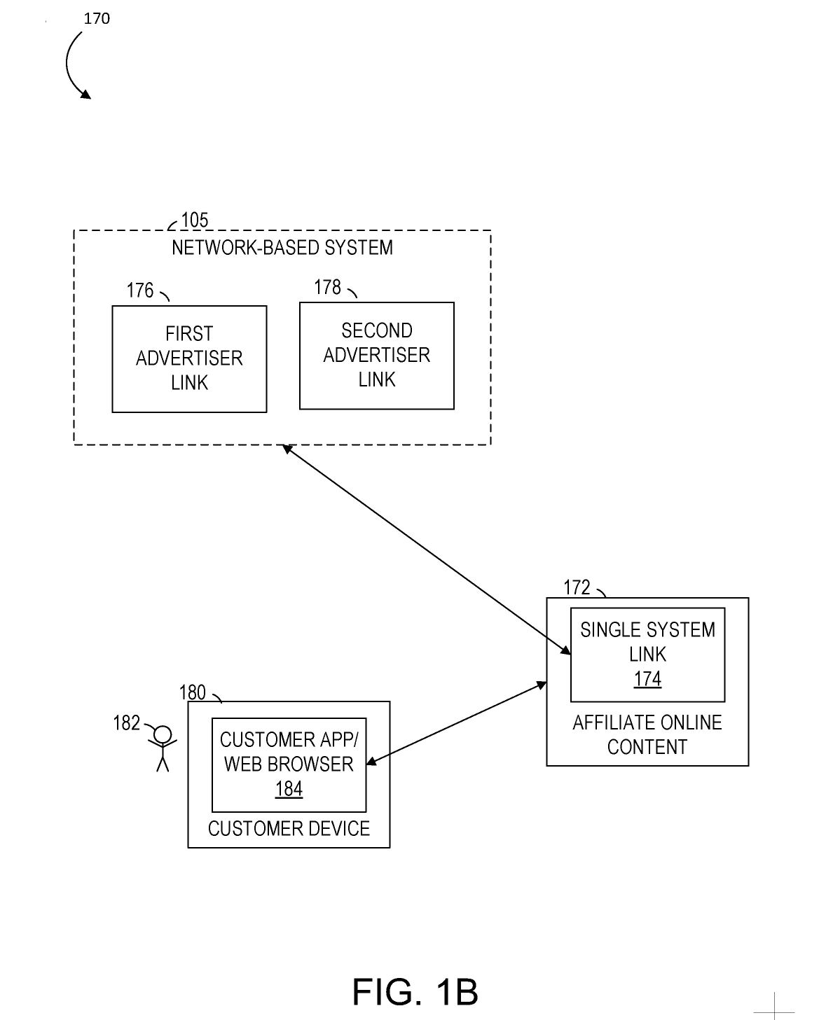

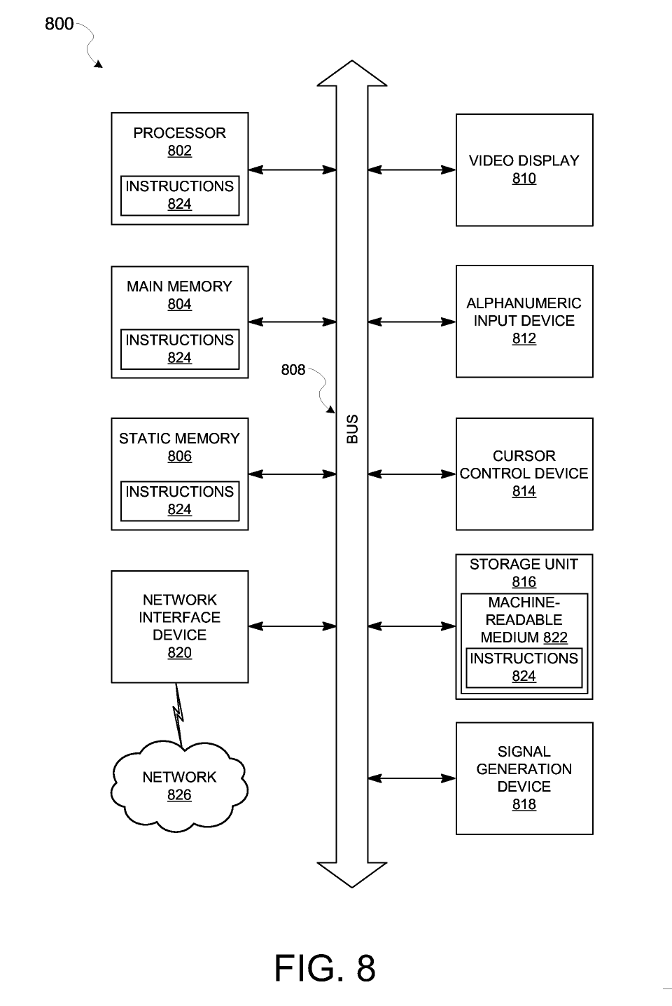

Referring to FIG. 1A, a network diagram illustrating an example network environment 100 suitable for performing aspects of the present disclosure is shown, according to some embodiments. The example network environment 100 includes a server machine 110, a database 115, an advertiser device 130 for an advertiser user 132, an affiliate device 140 for an affiliate user 142, and an admin device 150 for an admin user 152, all communicatively coupled to each other via a network 120. The server machine 110 may be implemented by a physical server machine, a virtual server machine, or a combination of the two. may form all or part of a network-based system 105 (e.g., a cloud-based server system configured to provide one or more services to the advertiser device 130, affiliate device 140 and admin device 140). The server machine 110, the advertiser device 130, the affiliate device 140, and the admin device 150 may each be implemented in a computer system, in whole or in part, as described below with respect to FIG. 8.

Also shown in FIG. 1A are the advertiser user 132, the affiliate user 142, and the admin user 152. One or more of the users 132, 142, and 152 may be a human user, a machine user (e.g., a computer configured by a software program to interact with the advertiser device 130), or any suitable combination thereof (e.g., a human assisted by a machine or a machine supervised by a human). The advertiser user 132 may be associated with the advertiser device 130 and may be a user of the advertiser device 130. For example, the advertiser device 130 may be a desktop computer, a vehicle computer, a tablet computer, a navigational device, a portable media device, a smartphone, or a wearable device (e.g., a smart watch or smart glasses) belonging to the first user 132. Likewise, the affiliate user 142 may be associated with the affiliate device 140, and the admin user 152 may be associated with the admin device 150.

In some embodiments, the devices 130, 140, and 150 may be configured to display user interfaces that are coupled to the network 120. For example, the advertiser device 130 may be configured to display and operate an advertiser user interface (UI) 134, the affiliate device 140 may be configured to display and operate an affiliate UI 144, and the admin device 150 may be configured to display and operate an admin UI 154. The UIs 134, 144, and 154 may be configured to receive inputs from a user, such as users 132, 142, and 152, respectively.

Any of the machines, databases 115, advertiser device 130, affiliate device 140 or admin device 150 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, 140, and 150. For example, a computer system able to implement any one or more of the methodologies described herein is discussed below with respect to FIG. 8. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the devices 130, 140, and 150). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

Referring to FIG. 1B, a relational diagram 170 is shown illustrating relational interactions between customers and the system of the third party marketing company, according to some embodiments. Here, the network-based system 105 of the third party marketing company, as previously described in FIG. 1A, may be configured to store a first advertiser link 176 and a second advertiser link 178. The links 176 and 178 may be stored in the database 115, for example. The first advertiser link 176 may cause customer traffic to be redirected to advertiser content related to a first advertiser campaign, while the second advertiser link 178 may cause customer traffic to be redirected to advertiser content related to a second advertiser campaign. These properties and other characteristics about the first and second links 176 and 178 may be specified by first and second advertisers, respectively, through utilizing the advertiser UI 134, for example.

Separately, an affiliate may have generated affiliate online content 172. Examples of the affiliate online content 172 may include websites associated with the affiliate (e.g., CNN.com or ESPN.com) or email newsletters or advertisements associated with the affiliate. As used herein, an affiliate website may be one example of the affiliate online content, but it is noted that any description about the affiliate website may also apply to other types of affiliate online content, such as email newsletters associated with the affiliate. Typically, the affiliate online content 172 may allow for advertiser links to be placed into the affiliate online content 172. That is, various advertisements, such as banner ads, skyscraper ads, pop-up ads, etc., may be viewable to a customer 182 when the customer, through a customer app or web browser 184 run on a customer device 180, when the customer accesses the affiliate online content. The various advertisements would typically include an advertiser link, such that, when the customer clicks on the advertisement, the customer is redirected to online content associated with the advertiser. Typically, the affiliate must work closely with one or more advertising companies to update the advertiser links on the affiliate online content 172. However, aspects of the present disclosure allow for the affiliate to place a single system link 174 on the affiliate's landing page of the affiliate online content 172 (e.g., placed in the landing page arising from a customer clicking on a banner ad), such that the network-based system 105 may redirect traffic from the single system link 174 to either the first advertiser link 176, the second advertiser link 178, or any other advertiser link deemed optimal to result in the most relevant or pertinent to customers of the affiliate online content. In this way, the affiliate need to only place the single system link 174 once in its online content, after which the network-based system determines what advertiser content to provide to customers of the affiliate through the single system link 174. In addition, the affiliate need not know what specific advertiser link is to be displayed in the affiliate online content, nor would the affiliate need to spend time collaborating with advertisers or the third party marketing company what advertiser content to show. Rather, in some embodiments, the network based system 105 may continually optimize the content in the space where the single system link 174 is positioned by redirecting customer traffic to the first advertiser link 176, the second advertiser link 178, or another advertiser link that may be most relevant to the customer traffic.

Example User Interfaces

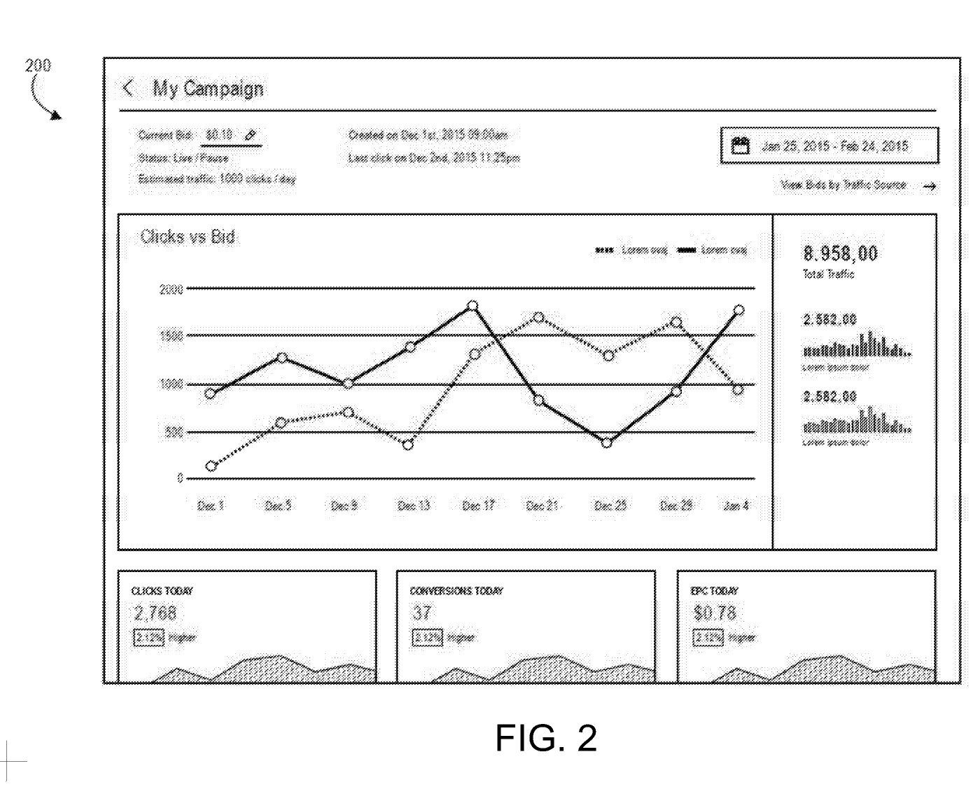

Referring to FIG. 2, illustration 200 shows an example display of various information for running an ad campaign, according to some embodiments. The example display in illustration 200 may be part of the advertiser UI 134 displayable in the advertiser device 130, for example. Here, various information about the ad campaign for an advertiser may be viewed. For example, the advertiser may be able to view an amount of the traffic occurring through the ads in the ad campaign, based on actual clicks per day, for example. The actual number of clicks may be tracked graphically in a chart plotting number of clicks per day over a period of days. The charts may also contain other information, such as the number of positive actions resulting from the clicks, such as purchases on the advertiser's website, email subscriptions, or whatever other metric the advertiser may be using to judge the efficacy of the ad campaign (sometimes referred to as conversions). In addition, revenue generated by the ad campaign may also be displayed.

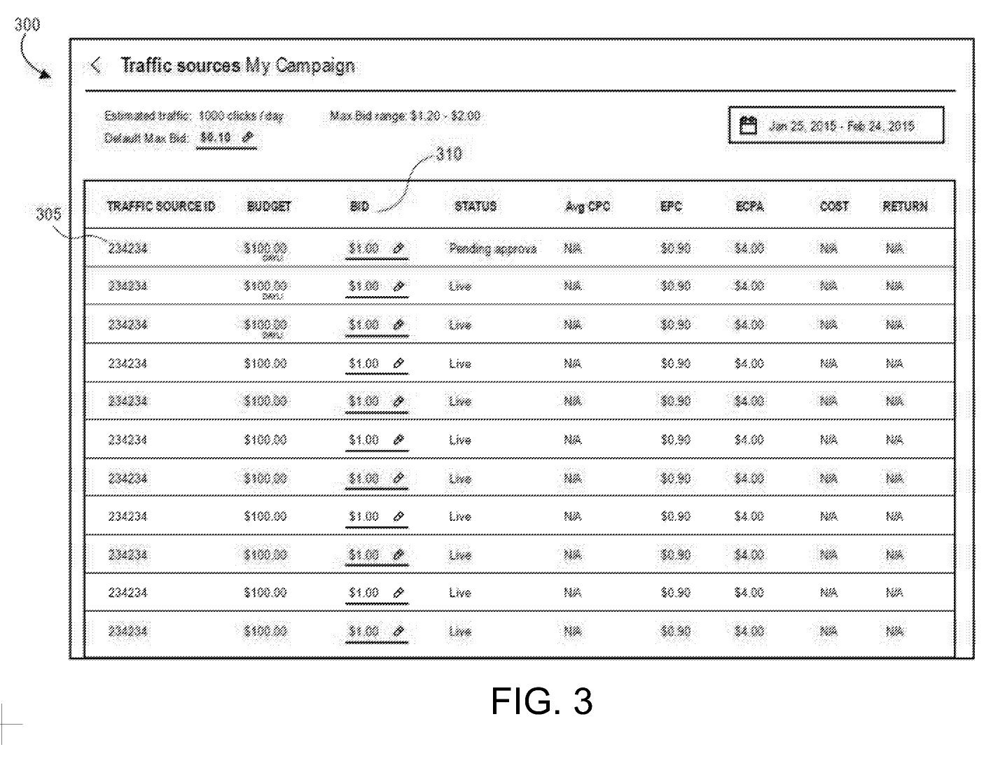

Referring to FIG. 3, illustration 300 shows a second example display of various traffic sources for running an ad campaign, according to some embodiments. A traffic source may refer to a link associated with an online advertisement that when clicked on, causes the customer to be taken to a website of the advertiser. In one campaign, the advertiser may have set up multiple traffic sources, where each traffic source may be displayed in different affiliate websites. The traffic source list 305 shows a plurality of traffic sources, organized by traffic source ID. For each traffic source, the example display may also include a daily budget indicating how much money has been allocated to display the traffic source per day, a status of the operation of the traffic source, an estimated cost of the traffic source, an estimated return of the traffic source, and various profit statistics. In some embodiments, the advertiser UI 134 may also allow for the display of the traffic sources to be priced based on an auction system or other type of dynamic pricing system, as shown in the bid column 310. The dynamic pricing functionality available according to some embodiments will be described more, below.

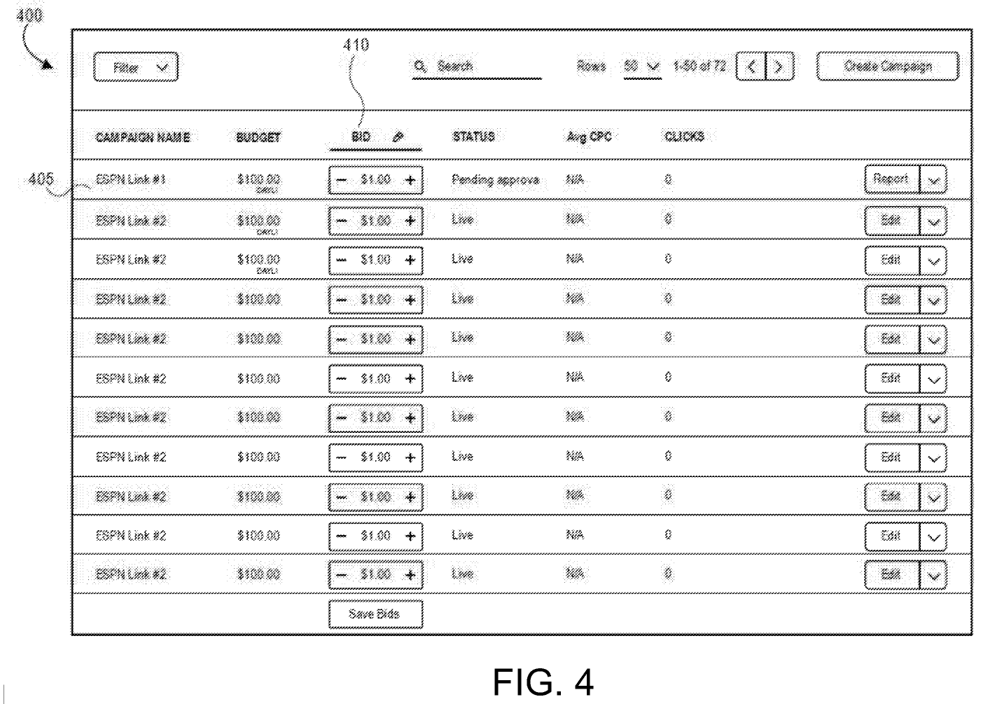

Referring to FIG. 4, illustration 400 shows a third example display of various campaigns running simultaneously by the advertiser, according to some embodiments. Here, a listing of ad campaigns 405 may be displayed, where each ad campaign may include one or more links directing a customer to an advertiser's website. In some embodiments, multiple traffic sources can be included in any one particular ad campaign. Each ad campaign listed may include additional statistics or other information, such as a daily budget, a present status of the campaign, a number of clicks on the link leading to the advertiser's website, and any estimated profit or return from the ad campaign. In some embodiments, the advertiser UI 134 may also allow for each campaign to be priced based on an auction system or other type of dynamic pricing system, as shown in the bid column 410. The dynamic pricing functionality according to some embodiments will be described more, below.

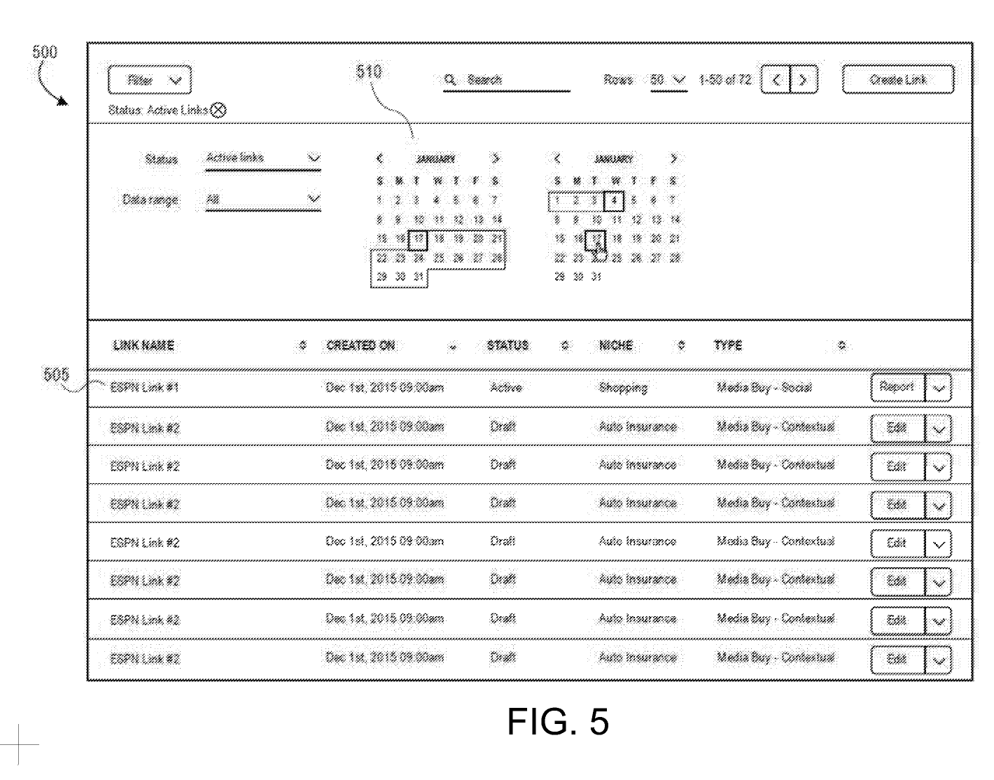

Referring to FIG. 5, illustration 500 shows a fourth example display of an interface for viewing when links associated with an ad campaign will be displayed, according to some embodiments. In some cases, the example display in illustration 500 may be interacted with through an interface of the affiliate, such as the affiliate UI 144. For example, the affiliate user may be able to view the various ad campaign links 505 provided to it through the system of the third-party marketing company, after it has been decided that the various links of the advertisers are deemed suitable for display in an affiliate website. The affiliate may be able to view various statistics and other information about the advertiser links in the listing 505, such as date created, status of the link, what marketing niche the link may be associated with, and what marketing type the link may be associated with. In some embodiments, the affiliate may also be able to view dates for when the links of the advertiser will be displayed, based on the calendars 510.

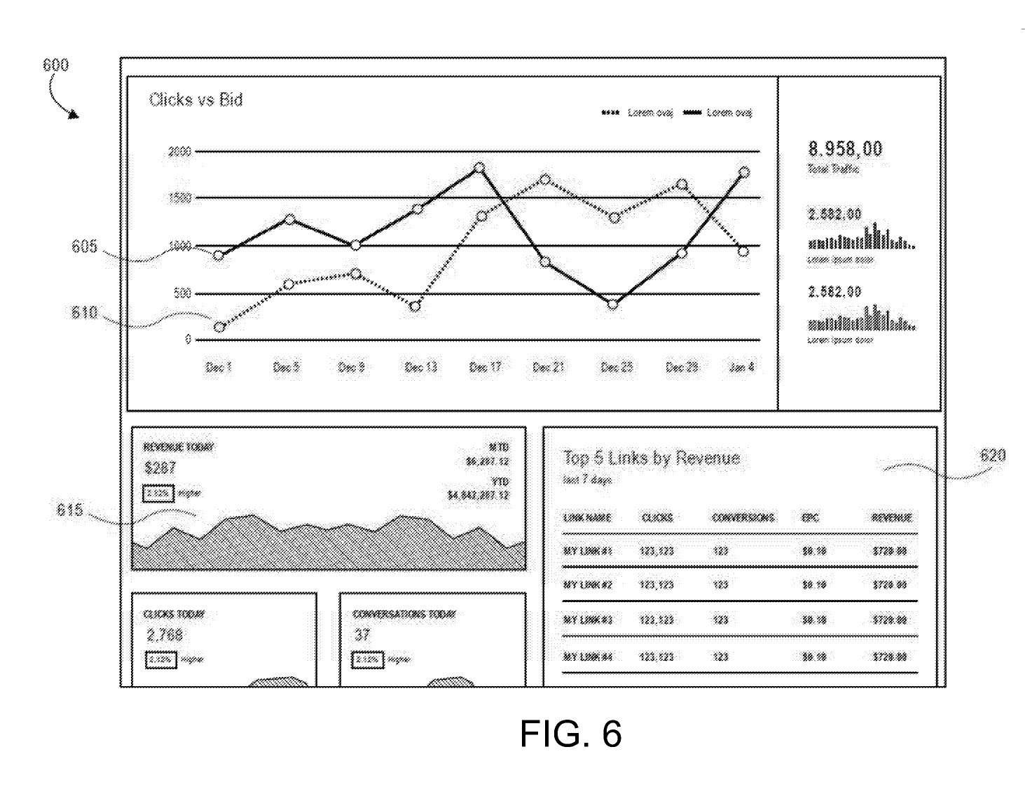

Referring to FIG. 6, illustration 600 shows a fifth example display showing revenue information that may be generated from one or more links, according to some embodiments. The example display in illustration 600 may be viewable in the affiliate UI 144, for example. Here, an affiliate user may be able to view the amount of revenue generated by one or more links deployed on the affiliate website or embedded in the affiliate's email newsletter. For example, the line graphs 605 and 610 may illustrate amounts of revenue generated by a first link displayed in the affiliate website and a second link displayed in a different location on the affiliate website. The line graphs 605 and 610 may display the amount of revenue generated per day across multiple days. In some embodiments, the affiliate user may also be able to view how much revenue has been generated on the current day and across larger time periods, such as month to date or year-to-date timings, as shown in example graphic 615. In some embodiments, the example graphic 615 may show revenue for a single link, while in other cases the amount of revenue displayed may be representative of the aggregate amount of revenue generated on the affiliate website based on the sum total of all links displayed in the affiliate website. In some embodiments, the example display may also show the best performing links by revenue, as shown in the example graphic 620. Here, various other statistics about each of the top ranking links may be shown. The affiliate UI 144 may also be able to display other information, such as a number of clicks per day for a single link or based on the aggregate of links on the affiliate website, as well as total number of conversions for one or all links on the affiliate website. Of note, while affiliate websites are discussed herein as a domain for which advertiser links may be placed, the system according aspects of the present disclosure may also support placement of links into emails and other online communications, and associated revenue may be viewed herein as well.

In some embodiments, the admin UI 154 may be configured to interact with any or all of the example displays in FIGS. 2-6. That is, in admin user may also be able to view any of the displays presented to either the affiliate user or the advertiser user. The admin user may be able to monitor what information is being displayed to the affiliates and the advertisers, as well as edit or debug any issues occurring on any of the example displays.

Example Methods for Optimizing Affiliate Links

The following are example descriptions for how aspects of the present disclosure may facilitate advertising interactions between one or more advertisers and one or more affiliates, including optimizing affiliate links, for example, when an advertiser's budget to display a particular ad is reached, according to some embodiments.

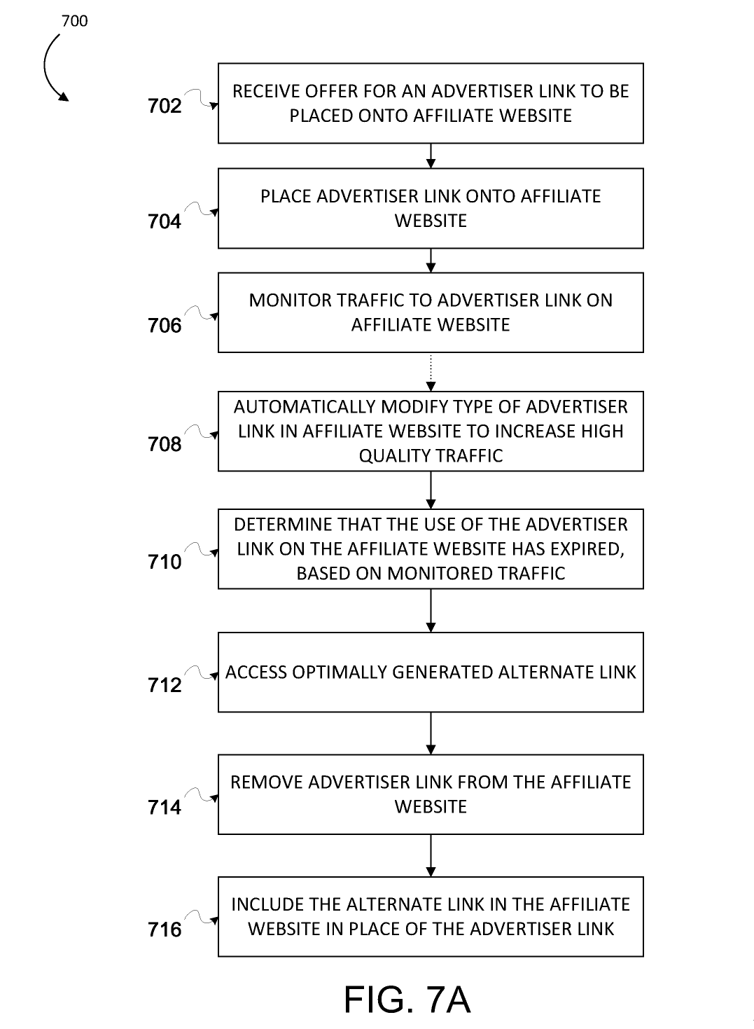

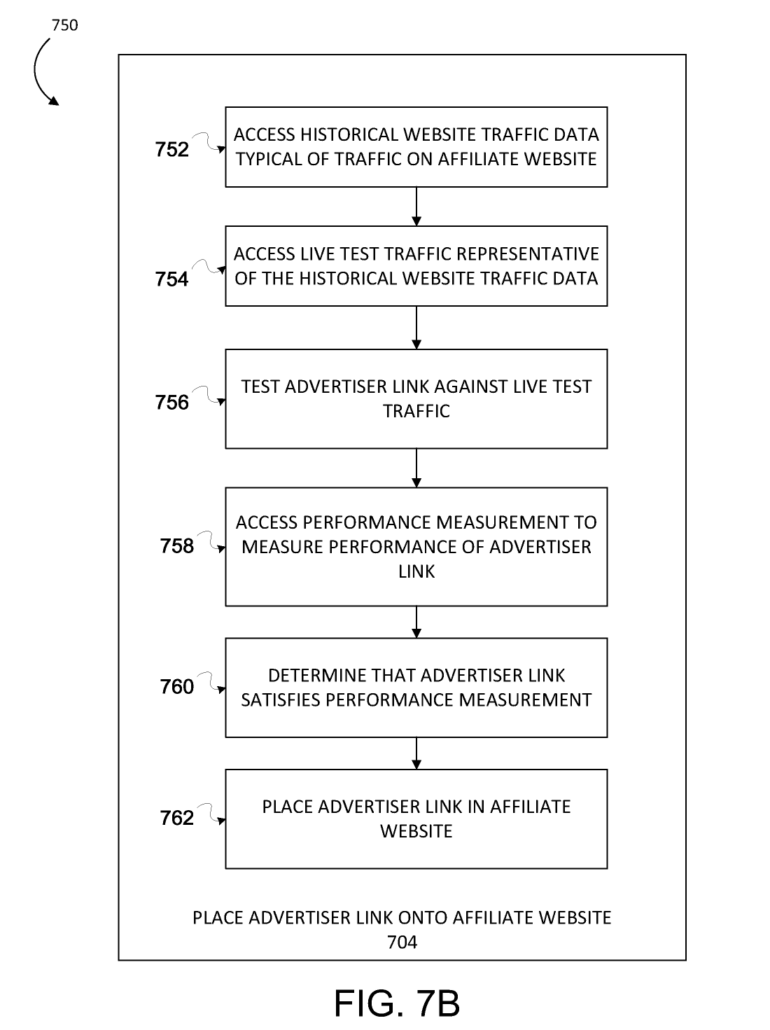

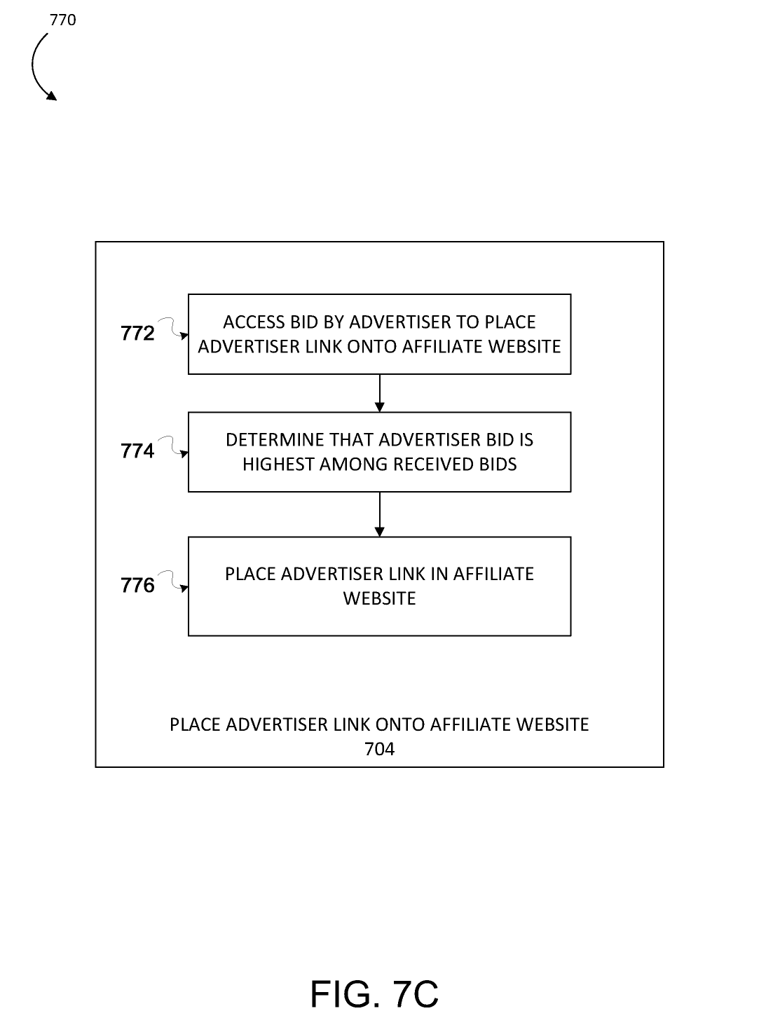

Referring to FIG. 7A, flowchart 700 provides an example methodology for facilitating advertising links on an affiliate website, using an advertiser link and an alternate link when the budget to display the advertiser link has reached its limit, according to some embodiments. The example methodology described herein may be performed by a system of the third-party marketing company, such as the network-based system 105. The system of the third-party marketing company may also be in control of the advertiser UI 134, the affiliate UI 144, and the admin UI 154, according to some embodiments. The system of the third-party marketing company may be configured to receive inputs from various users through these example user interfaces 134, 144, and 154. These inputs may be received at the server 110, transferred through the network 120, and stored in the database 115, for example.

At block 702, the system may be configured to receive an offer for an advertiser link to an advertiser's website to be placed onto an affiliate website, in some embodiments. For example, an advertiser user 132 may enter one or more inputs into the advertiser UI 134 to select an advertisement to be displayed in an affiliate website. The selection may represent an offer to have the advertiser link be placed onto an affiliate website. The selected advertisement may also contain a link that, when a customer clicks on the selected advertisement, the customer will be directed to a website of the advertiser. At this point, the advertiser may not know which affiliate website will display the advertiser link. In some embodiments, additional inputs to complete the offer may include pricing parameters for how the advertiser will pay to display the advertisement. An example may include paying an affiliate website per click on the advertiser link, e.g., each time a viewer on the affiliate website clicks on the advertiser link, the advertiser pays the affiliate $0.50 per click. Another example input may include specifying how many days the advertiser link should be displayed, or during what time periods in a day the advertiser link should be displayed. Another example input may include a geo location of the customer. In some embodiments, the pricing parameters may be correlated with the duration, frequency, or time of day for which the advertiser link will be displayed. In some embodiments, the pricing parameters may also represent a bid to place the advertiser link onto the affiliate website, where the advertiser link with the winning bid among multiple bids means the advertiser link is selected for placement onto the affiliate website.

At block 704, the system may be configured to place the advertiser link onto a particular affiliate website, according to some embodiments. For example, an affiliate user 142 may place a single link associated with the system onto their website (or email newsletter of the affiliate, etc.). This single link may signal to the system that the affiliate website is available to display advertiser links. The system may also receive through the affiliate UI 144 a description about the affiliate website and/or descriptions about the customers who view the affiliate website. In some embodiments, the system may then be configured to compare metadata of the affiliate website and other associated descriptions about the affiliate website with the offer to place the advertiser link. In some embodiments, the system may perform this comparison through examining or comparing various pieces of information, such as the intended target audience of the advertiser link, the type of customers who frequent the affiliate website, and whether pricing parameters as specified by the advertiser and the affiliate match, with the descriptions of the offer to place the advertiser link. For example, a proposed price or set of pricing parameters offers in block 702 may match desired pricing parameters of the affiliate website. Also, the desired type of ad, including the type of viewers who tend to view the affiliate website, may match a specified market niche desired to be reached by the advertiser link. The system may then be configured to direct traffic through the single system link on the affiliate website to the content of the ad campaign associated with the advertiser link.

At block 706, the system may be configured to monitor traffic to the advertiser link on the affiliate website. In some embodiments, various programming code may be embedded in the placement of the advertiser link to provide metadata to the system that enables the system to record various statistics, including what kind of traffic the advertiser link is experiencing on the affiliate website. In some embodiments, this information may be displayed in the advertiser UI 134 and/or the affiliate UI 144. In some embodiments, the monitoring may include monitoring the quality of traffic directed toward the advertiser link, and/or how much of the advertiser's budget is being spent, based on the customer activity directed toward the advertiser link.

In some embodiments, at block 708, the system may be configured to automatically modify the type of the advertiser link in the affiliate website to increase the quality of traffic. For example, the system may dynamically change which advertiser link the customer will be redirected to, when clicking on the single system link. For example, the system may originally redirect traffic from the single system link to the content of the advertiser link of block 702, but then may dynamically redirect traffic to a second advertiser link when the customer clicks on the single system link. In some embodiments, the modified selection may also be based on consumer testing performed on the advertiser link and any associated ad campaigns.

At block 710, the system may be configured to determine that the use of the advertiser link on the affiliate website has expired, based on the monitored traffic. For example, the system may determined that the advertiser budget for the link has been used up, such that the advertiser link will no longer be displayed in the affiliate website. For example, it may be determined that the advertiser may have set a daily budget for the link to be five dollars, and that the advertiser pays the affiliate $0.50 per click on the advertiser link. The system may determine that 10 people have already clicked on the advertiser link through the affiliate website, thereby exhausting the advertiser budget for that link, for that day. Because the advertiser link can no longer be used having reached its budget, in some cases, a new link of a different advertisement should be displayed in place of the expired advertiser link.

At block 712, the system may then access an optimally generated alternate link to be displayed in place of the advertiser link that has expired. In some embodiments, for each customer that comes off of an affiliate website, the system may serve an ad which has the highest chance of resulting in conversions. There are numerous factors used to determine what alternate link to use, such as historical conversion ratios of the advertiser's ad campaign, geolocation matching between campaign and customer, previous actions done by customers on other links, max bid price as set by the advertiser, device type of the customer, and available advertiser budget, among others. Aspects of the present disclosure allow for the affiliate to have just a single link provided in the affiliate website that can be used to display both the advertiser link and the alternate link. This may be in contrast with conventional methods that require a more manual process to switch out the expired link with the alternate link.

At block 714, in some embodiments, the system may be configured to remove the advertiser link from the affiliate website. That is, the system may render the advertiser link and operable or may simply decouple the advertiser link from the affiliate website. At block 716, the system may then include the alternate link in the affiliate website in place of the advertiser link. As mentioned before, in some embodiments, the affiliate may not need to be involved in any part of the process of deciding what alternate link should be used in place of the expired advertiser link. In some embodiments, the affiliate may provide simply a single link where advertisements may be placed in the affiliate website, whereby the system may interface with just that single link to place the advertiser link and then later substitute the advertiser link for the alternate link.

Referring to FIG. 7B, flowchart 750 provides additional details for what the system may perform at block 704, i.e., receiving an input to provide the advertiser link on to the affiliate website, according to some embodiments. For example, the system may perform an automated testing process to determine whether to include the advertiser link onto the affiliate website. In conventional methods, when an advertiser link is submitted into an advertising network, two teams of employees—market research and/or the publisher relations team—identify the advertiser link as a campaign worthy of testing, and draw up a list of targets (based on people currently running in that vertical or a similar vertical and/or people who have run that vertical or a similar vertical in the past). Then they talk to those targets and convince/request that they put in a test for the campaign. This means that an affiliate will typically run a test of 25-500 clicks to determine the campaign's performance. They might be shifting traffic from a competitor network's offer to run the campaign or shifting traffic among offers on the third party marketing company's network. Then the test needs to be monitored and evaluated to determine if it is meeting the internal metrics to deem it worthwhile of scaling up. Then the publisher rep needs to confirm that the publisher is confident in the campaign and that the publisher is going to scale up the traffic. Aspects of the present disclosure, according to some embodiments, replace all of this manual process. In some cases, the client will not even be aware when a new offer is added into the mix and testing can start as soon as the advertisers bids and targeting allow.

In some embodiments, the system will auto test every new campaign. What this means is that the system will measure the performance of the campaign and based on that measured performance, will serve it to the traffic that is most likely to convert. This could mean that a certain campaign works better in a specific geo-location or with traffic from a specific site, among other factors. The system will identify where the highest quality traffic is coming from, and then try to increase the volume of that high quality traffic automatically. Further, in some embodiments, this testing is not only done at the outset of the campaign, but rather does so continuously throughout the life of the campaign.

For example, at block 752, the system may access historical website traffic data typical of traffic on the affiliate website. That is, the system may first obtain traffic data representative of the type of traffic typically experienced by the affiliate website. For example, the representative traffic data may include customers following certain patterns, such as a common geolocation, a common interest, a common economic status, a common religious preference, and so forth. This website traffic data may be stored in a database that may be collected from various metadata previously monitored from the affiliate website. In other cases, this representative traffic data may be gleamed from websites similar to the affiliate website, in the event that there is insufficient data about the affiliate website.

At block 754, the system may access test traffic representative of the affiliates typical traffic, based on or consistent with the historical website traffic data. This traffic may be obtained through live testing of customers viewing websites that are within the system's network. In some embodiments, the customers comprising the test traffic data may be initially polled to determine whether they mirror or at least are consistent with the representative affiliate website traffic. In other cases, the system may simply monitor in real-time the actual customer traffic occurring on the affiliate website.

At block 756, the system may then test the advertiser link against the test traffic. That is, the system may record the responses, or lack thereof, of the various customers when the advertiser link is presented to the customers. The system may collect this data and make it available for statistical purposes.

At block 758, the system may access a performance measurement to evaluate the performance of the advertiser link against the representative test traffic. The system may compute and gather various performance metrics about the advertiser link. The performance measurement may be a value or statistic indicating a threshold to determine whether the advertiser link has generated a desired amount of traffic. For example, the performance measurement may be $100 of cost per action (CPA) per 100 clicks. In general, the system may utilize CPC (Cost Per Click) and EPC (Earnings Per Click) to optimize the campaigns to which the link directs.

At block 760, the system may determine that the advertiser link satisfies the performance measurement. For example, the system may determine, based on the measure traffic from the representative test traffic, that revenue generated from customers accessing the advertiser link exceeded some predetermined threshold amount. Based on satisfying the performance measurement, at block 762, the system may place the advertiser link in the affiliate website mirroring the placement and timing as tested. Thus, here, one of the inputs to provide the advertiser link onto the affiliate website includes the determination that the advertiser link satisfies the performance measurement.

Referring to FIG. 7C, flowchart 770 provides another example methodology providing additional details for how the system may perform blocks 704, i.e., receiving inputs to provide the advertiser link onto the affiliate website. For example, the system may allow for pricing of the advertiser link to be dynamically determined before placing the advertiser link onto the affiliate website. For example, in some cases, the pricing is defined per maximum bids. Advertisers will define their maximum bid for each click and then the system will charge them the minimum bid to “win” that click. This really means that the winning campaign will be charged the max bid of the 2nd runner up plus 1 cent. In conventional methods, advertisers pay one flat CPA fee to all affiliates at all times. In contrast, the system according to aspects of the present disclosure allows them to adjust their pricing on the fly so they may pay different affiliates differently and may even pay the same affiliate differently throughout the course of a given day. In some embodiments, the flowchart 770 may be combined with the flowchart 750 to be included into performing the method at block 704.

As an example of conducting the dynamic pricing method, at block 772, the system may access a bid by the advertiser to place the advertiser link onto the affiliate website. Examples of the bid may include any of the bids described in FIGS. 3-4. The bid may represent how much in advertiser is willing to pay per click received from a customer viewing the affiliate website.

At block 774, the system may determine that the advertiser bid is the highest among received bids for the advertising space in the affiliate website. That is, the system may also receive other bids from other potential advertisers vying for the same space in the affiliate website. The system may compare all of the bids for the space in the affiliate website, and may determine that the advertiser's bid is the highest.

At block 776, the system may then select the advertiser link to be placed into the affiliate website, having determined that the advertiser has “won” the bid. In some embodiments, the system may inform the advertiser of the price for which the advertiser will be charged per click of the advertiser link. In some embodiments, that charge may be the price of the second highest bid+1 cent.

In some embodiments, the process described above would be described as manual bidding, and automated billing may be offered as well. With the automated billing option, the advertiser would input the budget and price of conversion (CPA price), and the system will then decide for each advertiser what the maximum bid that they should be paying. This Max Bid will change based on many factors such as: traffic source, geo location, targeting, etc.

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine 110 or a client machine in a server-client network environment, or as a peer machine in a distributed (e.g., peer-to-peer) network environment. The machine 800 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 2-7C. The instructions 824 may also reside, completely or at least partially, within the main memory 804, within the processor 802 (e.g., within the processor's cache memory), or both, before or during execution thereof by the machine 800. The instructions 824 may also reside in the static memory 806.

Accordingly, the main memory 804 and the processor 802 may be considered machine-readable media 822 (e.g., tangible and non-transitory machine-readable media). The instructions 824 may be transmitted or received over a network 826 via the network interface device 820. For example, the network interface device 820 may communicate the instructions 824 using any one or more transfer protocols (e.g., HTTP). The machine 800 may also represent example means for performing any of the functions described herein, including the processes described in FIGS. 2-7C.

In some example embodiments, the machine 800 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database 115, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device such as machines 110, 130, 140, or 150, as well as cloud-based storage systems or storage networks that include multiple storage apparatus or devices such as machines 110, 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 822 is non-transitory in that it does not embody a propagating signal. However, labeling the tangible machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 802 or a group of processors 802) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 808) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via a network 826 (e.g., the Internet) and via one or more appropriate interfaces (e.g., an API).

The performance of certain operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method comprising:
receiving, by a processor, an offer for an advertiser link to be placed onto an affiliate website, the advertiser link directing a customer to a website of the advertiser;
receiving, by the processor, an input to place the advertiser link onto the affiliate website;
monitoring customer traffic to the advertiser link on the affiliate website;
determining that the use of the advertiser link on the affiliate website has expired, based on the monitored traffic;
accessing an optimally generated alternate link;
removing the advertiser link from the affiliate website; and
including the alternate link in the affiliate website in place of the advertiser link.

2. The method of claim 1, further comprising generating the optimally generated alternate link based on at least one of the following factors: historical conversion ratios of an ad campaign of the advertiser, geolocation matching between the campaign and the customer, previous actions done by customers on related links to the advertiser link, max bid price as set by the advertiser, device type of the customer, and available advertiser budget.

3. The method of claim 1, further comprising automatically modifying placement of the advertiser link in the affiliate website to increase higher quality traffic directed toward the advertiser link.

4. The method of claim 1, wherein receiving the input to place the advertiser link onto the affiliate website comprises:
accessing historical website traffic data typical of traffic on the affiliate website;
accessing live test traffic representative of the historical website traffic data;
testing the advertiser link against the live test traffic;
accessing a performance measurement to measure performance of the advertiser link against the live test traffic;
determining that the advertiser link satisfies the performance measurement; and
placing the advertiser link in the affiliate website.

5. The method of claim 1, wherein receiving the input to place the advertiser link onto the affiliate website comprises:
accessing a bid by the advertiser to place the advertiser link in the affiliate website;
determining that the advertiser bid is highest among received bids; and
placing the advertiser link in the affiliate website in response to said determination.

6. A system comprising:
a server comprising a processor;
an advertiser user interface (UI) communicatively coupled to the processor;
an affiliate UI communicatively coupled to the processor;
the processor configured to:
receive, from the advertiser UI, an offer for an advertiser link to be placed onto an affiliate website, the advertiser link directing a customer to a website of the advertiser;
receive, from the affiliate UI, an input to place the advertiser link onto the affiliate website;
monitor customer traffic to the advertiser link on the affiliate website;
determine that the use of the advertiser link on the affiliate website has expired, based on the monitored traffic;
access an optimally generated alternate link;
remove the advertiser link from the affiliate website; and
include the alternate link in the affiliate website in place of the advertiser link.

7. The system of claim 6, wherein the processor is further configured to generate the optimally generated alternate link based on at least one of the following factors: historical conversion ratios of an ad campaign of the advertiser, geolocation matching between the campaign and the customer, previous actions done by customers on related links to the advertiser link, max bid price as set by the advertiser, device type of the customer, and available advertiser budget.

8. The system of claim 6, wherein the processor is further configured to automatically modify placement of the advertiser link in the affiliate website to increase higher quality traffic directed toward the advertiser link.

9. The system of claim 6, wherein receiving the input to place the advertiser link onto the affiliate website comprises:
accessing historical website traffic data typical of traffic on the affiliate website;
accessing live test traffic representative of the historical website traffic data;
testing the advertiser link against the live test traffic;
accessing a performance measurement to measure performance of the advertiser link against the live test traffic;
determining that the advertiser link satisfies the performance measurement; and
placing the advertiser link in the affiliate website.

10. The system of claim 6, wherein receiving the input to place the advertiser link onto the affiliate website comprises:
accessing a bid by the advertiser to place the advertiser link in the affiliate website;
determining that the advertiser bid is highest among received bids; and
placing the advertiser link in the affiliate website in response to said determination.

11. A non transitory computer readable medium comprising instructions that, when interpreted by a processor, cause a machine to perform operations comprising:
receiving an offer for an advertiser link to be placed onto an affiliate website, the advertiser link directing a customer to a website of the advertiser;
receiving an input to place the advertiser link onto the affiliate website;
monitoring customer traffic to the advertiser link on the affiliate website;
determining that the use of the advertiser link on the affiliate website has expired, based on the monitored traffic;
accessing an optimally generated alternate link;
removing the advertiser link from the affiliate website; and
including the alternate link in the affiliate website in place of the advertiser link.

12. The computer readable medium of claim 11, wherein the operations further comprise generating the optimally generated alternate link based on at least one of the following factors: historical conversion ratios of an ad campaign of the advertiser, geolocation matching between the campaign and the customer, previous actions done by customers on related links to the advertiser link, max bid price as set by the advertiser, device type of the customer, and available advertiser budget.

13. The computer readable medium of claim 11, wherein the operations further comprise automatically modifying placement of the advertiser link in the affiliate website to increase higher quality traffic directed toward the advertiser link.

14. The computer readable medium of claim 11, wherein receiving the input to place the advertiser link onto the affiliate website comprises:
accessing historical website traffic data typical of traffic on the affiliate website;
accessing live test traffic representative of the historical website traffic data;
testing the advertiser link against the live test traffic;
accessing a performance measurement to measure performance of the advertiser link against the live test traffic;
determining that the advertiser link satisfies the performance measurement; and
placing the advertiser link in the affiliate website.

15. The computer readable medium of claim 11, wherein receiving the input to place the advertiser link onto the affiliate website comprises:
accessing a bid by the advertiser to place the advertiser link in the affiliate website;
determining that the advertiser bid is highest among received bids; and
placing the advertiser link in the affiliate website in response to said determination.
